(19) United States
(12) Patent Application Publication
(10) Pub. No.: US 2012/0169845 A1
(43) Pub. Date: Jul. 5, 2012

(54) METHOD AND APPARATUS FOR ADAPTIVE SAMPLING VIDEO CONTENT

(75) Inventors: Jae Hoon Kim, San Diego, CA (US); David M. Baylon, San Diego, CA (US); Limin Wang, San Diego, CA (US)

(73) Assignee: GENERAL INSTRUMENT CORPORATION, Horsham, PA (US)

(21) Appl. No.: 12/981,951

(22) Filed: Dec. 30, 2010

(51) Int. Cl. H04N 13/02; H04N 7/12

(52) U.S. Cl. 348/46; 375/240.26; 348/E13.074; 375/E07.026

(57) ABSTRACT

In a method of encoding video, the video is analyzed to determine a sampling format for the video from a plurality of sampling formats. The video is sampled using the determined sampling format to produce a video portion having a subset of information of the video. The video portion is encoded to form an output bit stream.

### BACKGROUND

Depth perception for a three dimensional television (3D TV) is provided by capturing two views, one for the left eye and other for the right eye. By showing left/right view to left/right eye, respectively, depth information is estimated in the brain, and 3D scenes are perceived by stereopsis. Two full resolution left and right views can be transmitted, or as a solution to save bandwidth, the views are known to be filtered, down-sampled, rearranged, and compressed before transmission.

The Joint Video Team (JVT) has released a draft amendment (JVT-AE204 (Draft advanced video coding (AVC) amendment text to specify constrained Baseline profile, Stereo High profile, and frame packing supplemental enhancement information (SEI) message)) defining a new SEI message indicating spatial interleaving of video content for such uses as stereoscopic video delivery. In the amendment, frame packing arrangement types are defined, for example, checkerboard, column, side-by-side and top-bottom. The SEI message informs the decoder which frame packing arrangement type was used to encode the picture. The frame packing SEI informs the decoder that the output decoded picture contains samples of a frame consisting of multiple distinct spatially packed constituent frames using an indicated frame packing arrangement, which can be used to process the samples of constituent frames appropriately for display. The frame packing arrangement type does not change for a given 3D video program for most current instances.

### SUMMARY

According to an embodiment, a method of encoding video is disclosed. The method includes analyzing the video to determine a sampling format for the video from a plurality of sampling formats. The video is sampled using the determined sampling format to produce a video portion having a subset of information of the video. The video portion is encoded to form an output bit stream.

According to another embodiment, a method of decoding a bit stream is disclosed. The method includes receiving the bit stream having an encoded video portion and a sampling format previously used to sample the video portion prior to encoding. The encoded video portion is decoded to form the decoded video portion. The decoded video portion is upsampled based on the sampling format to generate a full video.

According to another embodiment, an encoder is operable to encode video. The encoder includes a module to analyze video to determine a sampling format for the video from a plurality of sampling formats, sample the video using the determined sampling format to produce a video portion having a subset of information of the video, and encode the video portion to form an output bit stream. The encoder also includes a processor to implement the module.

According to another embodiment, a decoder is operable to decode a bit stream. The decoder includes a module to receive the bit stream having an encoded video portion and a sampling format previously used to sample the video portion prior to encoding, decode the encoded video portion to form a decoded video portion, and upsample the decoded video portion based on the sampling format to generate full video. The decoder also includes a processor to implement the module.

Examples of the disclosure provide methods and apparatuses for encoding and decoding video. The methods and apparatuses may be used to analyze and decide a sampling or sub-sampling format, when the video sequence is encoded, that substantially maximizes coding efficiency for the video. For example, in instances in which the video to be coded consists of black and white horizontal stripes with one pixel height, horizontal sampling (or side-by-side arrangement for 3D video) provides a lower encoding cost than vertical sampling (or top-bottom arrangement for 3D video) because horizontal sampling will provide lossless sub-sampling. Similarly, for black and white vertical stripes vertical sampling (or top-bottom arrangement for 3D video) will be the optimal sampling scheme. The optimal arrangement type changes as textures in the video content change.

### BRIEF DESCRIPTION OF THE DRAWINGS

Features of the invention will become apparent to those skilled in the art from the following description with reference to the figures, in which:

FIG. 1 illustrates a functional block diagram of an adaptive sampling encoding system, according to an embodiment of the invention;

FIG. 2A illustrates a functional block diagram of a 3D adaptive sampling encoding system, according to an embodiment of the invention;

FIG. 2B illustrates a functional block diagram of a 3D adaptive sampling system with SEI, according to an embodiment of the invention;

FIG. 3 illustrates a functional block diagram of an adaptive sampling decoding system, according to an embodiment of the invention;

FIG. 4 illustrates a functional block diagram of a 3D adaptive sampling decoding system, according to an embodiment of the invention;

FIG. 5 illustrates a flow diagram of a method of encoding video content, according to an embodiment of the invention;

FIG. 6A illustrates a flow diagram of a method of encoding 3D video content, according to an embodiment of the invention;

FIG. 6B illustrates a flow diagram of a method of encoding 3D video content with SEI, according to an embodiment of the invention;

FIG. 7 illustrates a flow diagram of a method of decoding 2D video content, according to an embodiment of the invention;

FIG. 8 illustrates a flow diagram of a method of decoding 3D video content, according to an embodiment of the invention; and

FIG. 9 shows a block diagram of a computer system that may be used in encoding video content, according to an embodiment of the invention.

### DETAILED DESCRIPTION

For simplicity and illustrative purposes, the present disclosure is described by referring mainly to an example thereof. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure. As used herein, the term “includes” means includes but not limited to, the term “including” means including but not limited to. The term “based on” means based at least in part on.

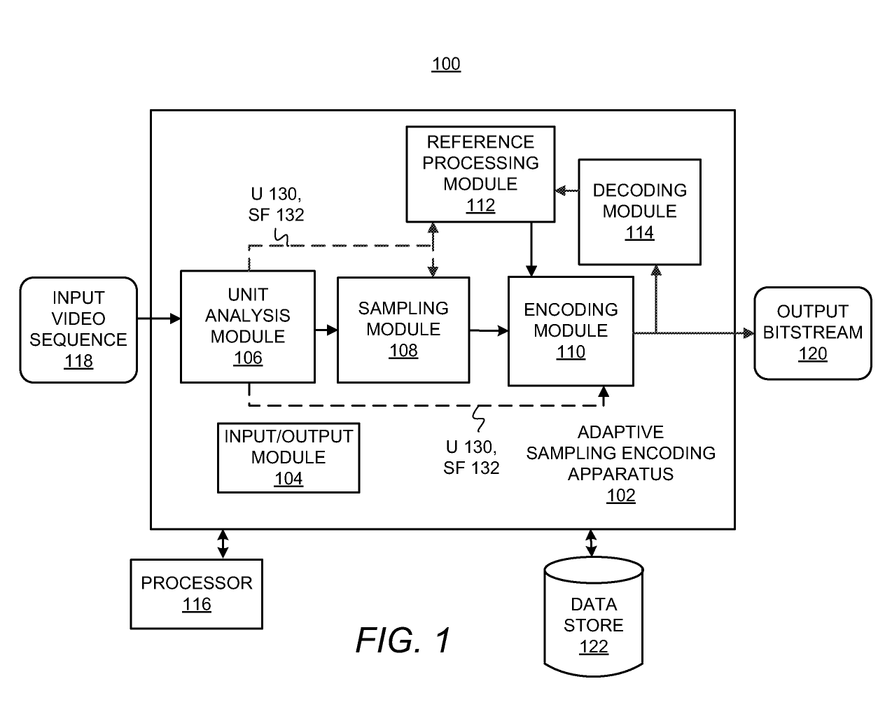

With reference first to FIG. 1, there is shown a simplified block diagram of an adaptive sampling encoding system 100 for encoding an input video 118. The input video 118 may comprise, but is not limited to, 2D video, 3D stereoscopic video, multiple view video, ‘view and depth’ video, and any sequence of pictures. It should be understood that the adaptive sampling encoding system 100 may include additional components and that one or more of the components described herein may be removed and/or modified without departing from a scope of the adaptive sampling encoding system 100.

The adaptive sampling encoding system 100 determines a sampling format for the input video 118 based on textures of the video. This determination may be referred to as adaptive sampling the input video 118. The sampling format identifies portions of the data used for encoding. The video may be analyzed to determine a unit type for the video from a plurality of unit types. The unit types may comprise a group of pictures, a picture, a slice, a group of blocks, a macroblock or a sub-macroblock. The determined unit type substantially maximizes coding efficiency.

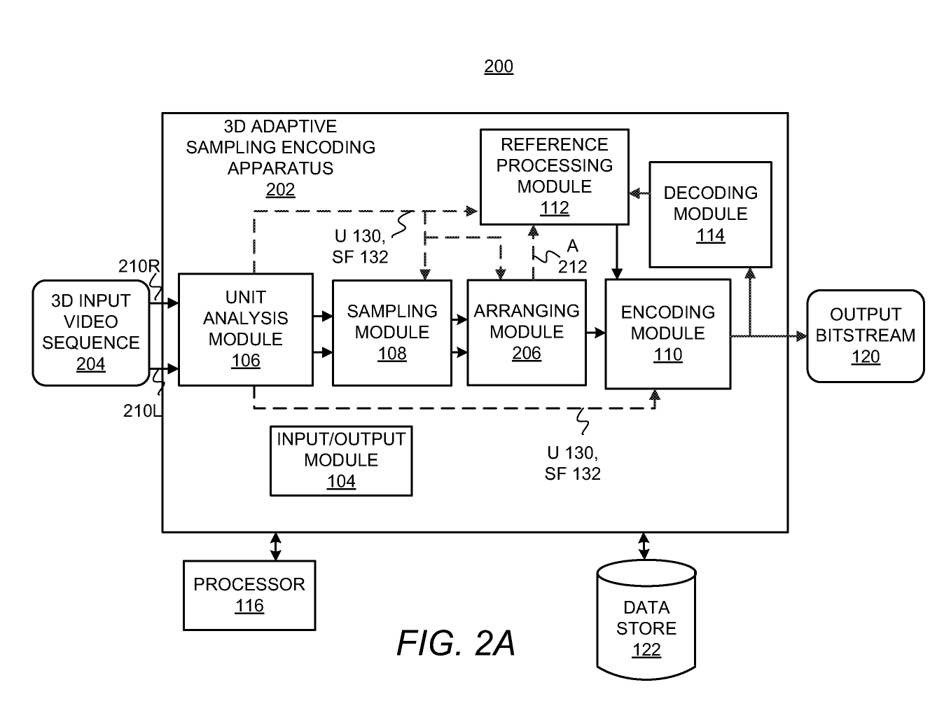

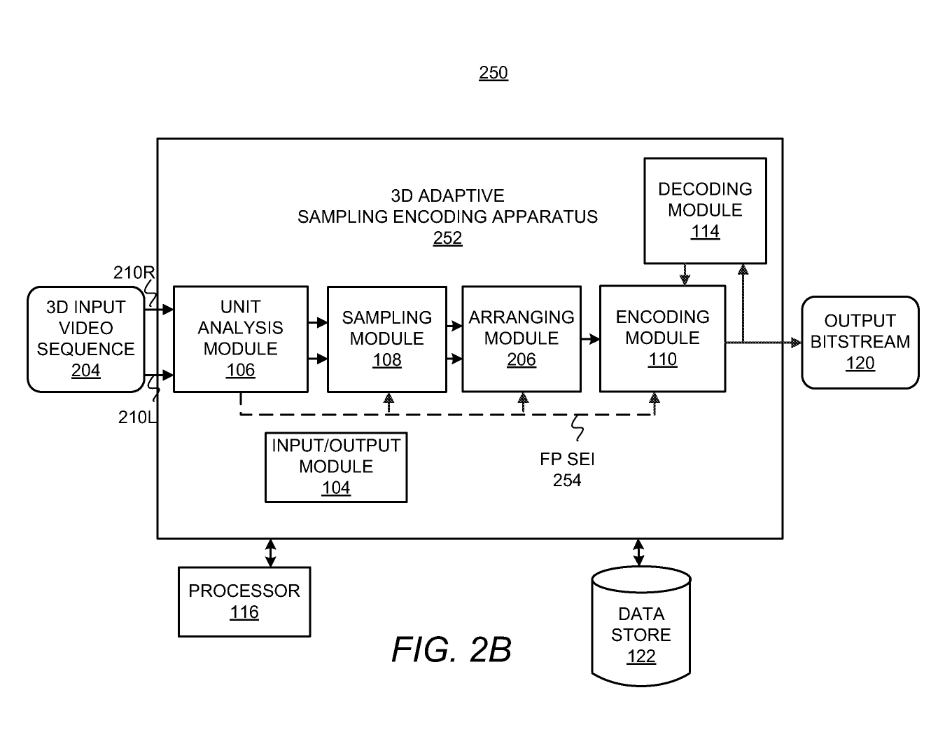

The adaptive sampling encoding system 100 determines unit type, sampling type as described with respect to FIG. 1, and arrangement type described hereinbelow with respect to FIG. 2, based on a cost function. For example, if D is the distortion (e.g. mean-squared error) associated between the original unit and the reconstructed unit, and R is the number of bits used to encode the unit, then a cost function can be defined to be

J=D+lambda*R, Equation (1)

in which lambda is a parameter that weighs the relative rate and distortion. The unit type, sampling type, and arrangement type can be chosen from a plurality of types to minimize the cost function J. The total cost over all units can also be minimized.

The sampling format used for encoding the input video 118, as determined based on coding efficiency, is dependent on textures in the given video. The video, for instance a group of pictures, a picture, a slice, a group of blocks, a macroblock or a sub-macroblock, has a directional preference for sampling and compression that correlates in instances to a particular sampling format. For example, in instances in which the video consists of black and white horizontal stripes with one pixel height, horizontal sampling is more efficient for coding the video than vertical sampling.

The input video 118 is video content that is to be encoded, for example, for transmission to user premises. For instance, the input video 118 may comprise video content, such as but not limited to, video content from broadcast programs, Internet Protocol TV (IPTV), switched video (SDV), video on demand (VOD) or other video sources. The input video 118 may comprise two-dimensional (2D) or alternately three-dimensional (3D) video content. In instances in which the input video 118 is 3D video content, the input video 118 includes a first view and a second view (not shown) that enable the input video 118 to be displayed in 3D video format.

The adaptive sampling encoding system 100 is depicted as including an adaptive sampling encoding apparatus 102, a processor 116, and a data store 122. The adaptive sampling encoding apparatus 102 is also depicted as including an input/output module 104, a unit analysis module 106, a sampling module 108, an encoding module 110, a reference processing module 112, and a decoding module 114 which are described in greater detail herein below.

The input video 118 may comprise 2D video as described with respect to FIG. 1, or 3D video, having a left and right view, as described hereinbelow with respect to FIG. 2A, in which instance additional processing as described with respect to FIG. 2A is applied to the input video 118.

According to an example, as described with respect to the input video 118 received as 2D video in FIG. 1, the unit analysis module 106 determines a unit type (U 130) of the input video 118. The unit analysis module 106 may determine the U 130 based on content of the input video 118, and select the U 130 for which least information (such as but not limited to texture, features, edges, etc.) in the input video 118 is lost in the output bitstream 120 from among a plurality of unit types. The unit types may comprise, for example, group of pictures, picture, slice, group of blocks, macroblock and sub-macroblock. The unit analysis module 106 may determine information transmitted from among different unit types, select the unit type that loses the least amount of information as the U 130, and output the U130 to sampling module 108, encoding module 110 and reference processing module 112.

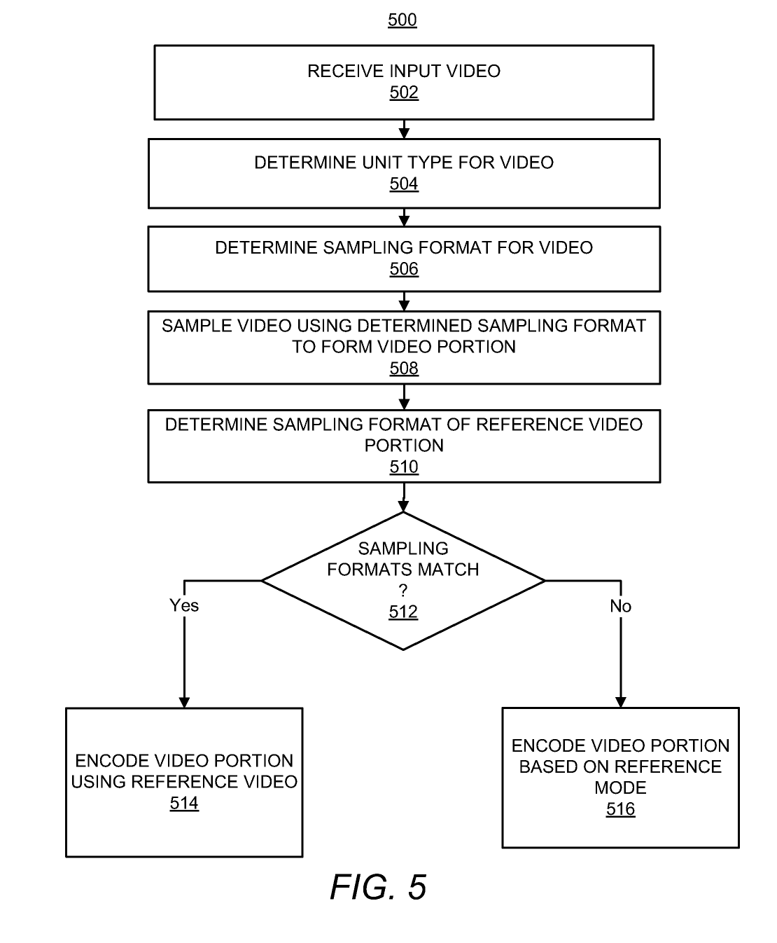

The unit analysis module 106 analyzes the input video 118 to determine a sampling format (SF 132) for the input video 118 from a plurality of sampling formats, such as but not limited to, horizontal sampling and vertical sampling. The unit analysis module 106 may determine the SF 132 by comparing encoding results for the plurality of different sampling formats. The encoding results may be compared based on the sampling format that has a lowest bit rate for the output bit stream 120 for the unit 130 as determined, for instance, using a rate distortion cost function such as J. Besides rate distortion cost function, as another example, frequency response analysis can be applied for the plurality of sampling formats. The unit analysis module 106 analyzes units of the video sequence 118, determines the SF 132 for each unit, for instance by computing a frequency response, for example, as described in detail hereinbelow with respect to FIG. 5 and the method 500, and outputs the SF 132 to sampling module 108, encoding module 110 and reference processing module 112.

The sampling module 108 samples the video using the U 130 and the SF 132 to produce a video portion. For example, the video may be pre-filtered using a horizontal filter or a vertical filter, and then subsequently sampled to produce the video portion.

The reference processing module 112 processes reference video for the current video portion to be encoded, using the U 130 and the SF 132 for the unit and decoded reference video from the decoding module 114, to determine reference video having the same U 130 and SF 132 as the current video portion in the encoding module 110. The decoding module 114 determines the decoded reference video from the output bit stream 120.

According to an example, in an instance in which the U 130 is picture, a sampled picture from the sampling module 108 may be in different format than the reference picture. Thus, when the current picture refers to a reference in different sampling format than the SF 132, the reference processing module 112 reshapes the reference picture by, for example, up-sampling (back to full resolution) and down-sampling (following the SF 132). This reshaped reference picture may be saved in the reference buffer so that it may be referred to for a subsequent operation without redundant up-sampling and down-sampling in instances in which the adaptive sampling encoding apparatus 102 contains sufficient buffer space. The reference values for the current video portion may also be directly computed using an interpolation method in instances in which buffer space is insufficient.

The filter used by the reference processing module 112 in the reference processing may be pre-defined and fixed. The filters used in pre/post-processing processes by the sampling module 108 may be used in reference processing by the reference processing module 112. According to an example as described with respect to high-performance video coding (HVC), a sub-pel interpolation filter, defined in H.264/AVC, may be used for reference processing by the reference processing module 112. Matching filters between pre/post-processing and reference processing substantially maximizes gains from adaptive sampling. Although the use of pre-defined filters may save signaling bits, the overall performance of the adaptive sampling encoding system 100 may be limited because the optimal pre/post-processing filters can change according to the sequences, display type, target application, etc. The filter for pre/post-processing may therefore be optimized for different applications. According to another example, filter coefficients may be signaled to maximize the overall gains.

The encoding module 110 then encodes the video portion to form the output bit stream 120. The encoding module 110 encodes the video portion using the reference video from the reference processing module 112. Various manners in which the modules 104-114 operate are discussed in detail herein below with respect to the method 500 depicted in FIG. 5.

According to an example, the adaptive sampling encoding apparatus 102 comprises machine readable instructions stored, for instance, in a volatile or non-volatile memory, such as DRAM, EEPROM, MRAM, flash memory, floppy disk, a CD-ROM, a DVD-ROM, or other optical or magnetic media, and the like. In this example, the modules 104-114 comprise modules with machine readable instructions stored in the memory, which are executable by a processor of a computing device. According to another example, the adaptive sampling encoding apparatus 102 comprises a hardware device, such as, a circuit or multiple circuits arranged on a board. In this example, the modules 104-114 comprise circuit components or individual circuits, which the processor 116 may also control. According to a further example, the adaptive sampling encoding apparatus 102 comprises a combination of modules with machine readable instructions and hardware modules. In addition, multiple processors may be employed to implement or execute the adaptive sampling encoding apparatus 102.

The adaptive sampling encoding system 100 may comprise a computing device and the adaptive sampling encoding apparatus 102 may comprise an integrated and/or add-on hardware device of the computing device. As another example, the adaptive sampling encoding apparatus 102 may comprise a computer readable storage device upon which machine readable instructions for each of the modules 104-114 are stored and executed by the processor 116. Thus, for instance, the adaptive sampling encoding system 100 may comprise an encoder.

Turning now to FIG. 2A, there is shown a simplified block diagram of a 3D adaptive sampling encoding system 200, according to an example. It should be understood that the 3D adaptive sampling encoding system 200 depicted in FIG. 2A may include additional components and that some of the components described herein may be removed and/or modified without departing from a scope of the 3D adaptive sampling encoding system 200. Note also that although the 3D adaptive sampling encoding system 200 is described with respect to 3D video, the 3D adaptive sampling encoding system 200 may be applied to multiview (more than two views) video. The 3D adaptive sampling encoding system 200 is a particular application of the adaptive sampling encoding system 100 disclosed with respect to FIG. 1 hereinabove. As such, the 3D adaptive sampling encoding system 200 includes many of the same elements as those depicted in the adaptive sampling encoding system 100 in FIG. 1.

The 3D adaptive sampling encoding system 200 is depicted as including a 3D adaptive sampling encoding apparatus 202, a processor 116, and a data store 122. The 3D adaptive sampling encoding apparatus 202 is an implementation of the adaptive sampling encoding apparatus 102 described hereinabove with respect to FIG. 1. In addition to the input/output module 104, the unit analysis module 106, the sampling module 108, the encoding module 110, the reference processing module 112, and the decoding module 114, the 3D adaptive sampling encoding apparatus 202 includes an arranging module 206.

The 3D adaptive sampling encoding apparatus 202 receives input 3D video 204, comprising for instance, two separate input videos corresponding to left and right views, herein 210R and 210L. Similarly as described hereinabove with respect to FIG. 1, the unit analysis module 106 may determine a unit type, for example, group of pictures, picture, slice, group of blocks, macroblock and sub-macroblock, for each of the left and right input video 210R and 210L. The 3D adaptive sampling encoding apparatus 202 applies adaptive sampling to the input 3D video 204, using the unit analysis module 106, and the sampling module 108, similarly as described with respect to FIG. 1 hereinabove.

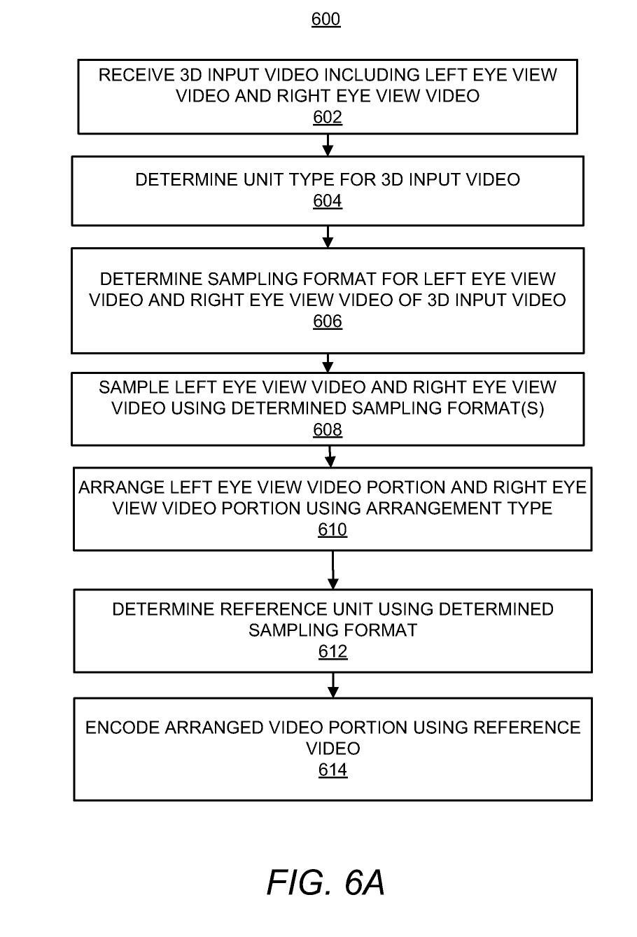

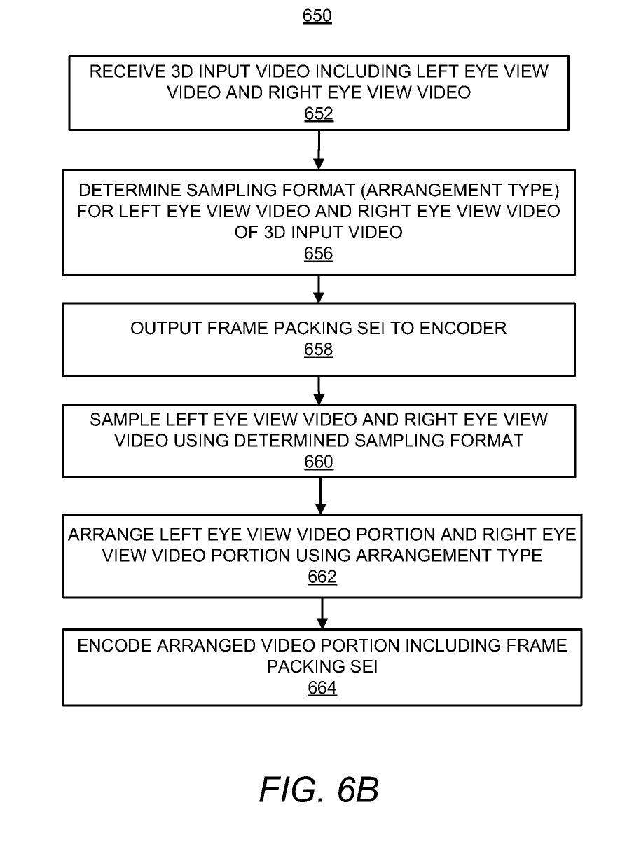

The 3D adaptive sampling encoding apparatus 202 generates a left eye view video portion and a right eye view video portion from the left and right input video, 210R and 210L respectively. For example, as described in detail hereinbelow with respect to FIG. 6A and the method 600, the 3D adaptive sampling encoding apparatus 202 may perform adaptive sampling of the left and right input video for video comprising unit types such as but not limited to slices of pictures in each of the left and right input video 210R and 210L. The unit analysis module 106 performs processes similar to those described hereinabove with respect to FIG. 1 and the adaptive sampling encoding system 100 to generate the U130 and the SF 132. The sampling module 108 samples each of the separate input video 210R and 210L to form the left eye view video portion and the right eye view video portion. The sampling module 108 may use different U130 and SF 132 for each of the input videos 210R and 210L to maximize coding efficiency. In 3D video, where left view video and right view video is similar with disparities in the objects for depth, the same U130 and SF132 may be used without reducing coding efficiency.

The arranging module 206 determines an arrangement type (A 212) for the left eye view video portion and the right eye view video portion, such as but not limited to a top-bottom arrangement, a side-by-side arrangement and an interleaved arrangement, and forms a single 3D video portion. The single 3D video portion is an arranged video portion from the left eye view video portion and the right eye view video portion. Note that in some instances the number of pixels in the single 3D video portion may be equal to the number of pixels in either full resolution left eye view video portion or full resolution right eye view video portion.

The encoding module 110 encodes the single 3D video portion to form an output bit stream 120. The encoding module 110 uses the reference video from the reference processing module 112 in encoding the single 3D video portion. When the output bit stream 120 is output by the encoding module 110, a reconstructed picture is saved as a reference in the reference buffer. Various manners in which the modules 104-114 and the module 206 operate in the 3D adaptive sampling encoding system 200 are discussed in detail herein below with respect to the method 600 depicted in FIG. 6A.

Turning now to FIG. 2B, there is shown a simplified block diagram of a 3D adaptive sampling encoding system 250, according to an example. It should be understood that the 3D adaptive sampling encoding system 250 depicted in FIG. 2B may include additional components and that some of the components described herein may be removed and/or modified without departing from a scope of the 3D adaptive sampling encoding system 250. The 3D adaptive sampling encoding system 250 is a particular application of the 3D adaptive sampling encoding system 200 disclosed with respect to FIG. 1 hereinabove. As such, the 3D adaptive sampling encoding system 250 includes many of the same elements as those depicted in the 3D adaptive sampling encoding system 200 in FIG. 2A.

As shown in FIG. 2B, the 3D adaptive sampling encoding apparatus 252 uses a frame packing (FP) SEI 254 to provide backward compatible bit stream that may be provided to decoders that are not operable to decode an output bit stream using a reference video that has been determined through adaptive sampling. As shown in FIG. 2B, in contrast to the 3D adaptive sampling encoding apparatus 202 in FIG. 2A, the 3D adaptive sampling encoding apparatus 252 may not include the reference processing module 112. The decoder that receives the output bit stream 120 that includes the FP SEI 254 may not use reshaping, instead performing the decoding using the FP SEI 254.

The unit analysis module 106 determines the FP SEI 254 and outputs the FP SEI 254 to the encoding module 110. The encoding module 110 includes the FP SEI 254 in the output bit stream 120. The FP SEI 254 may include information such as but not limited to for the U 130, the SF 132, and the A 212. The information in the FP SEI 254 may be used by the decoder that receives the output bit stream 120 to process the output bit stream 120. For the FP SEI described in JVT-AE204, the U 130 is fixed as a picture and the SF 132 and A 212 can be derived from the plurality of frame packing arrangement type including checkerboard, column based interleaving, row based interleaving, side-by-side, top-bottom and temporal interleaving.

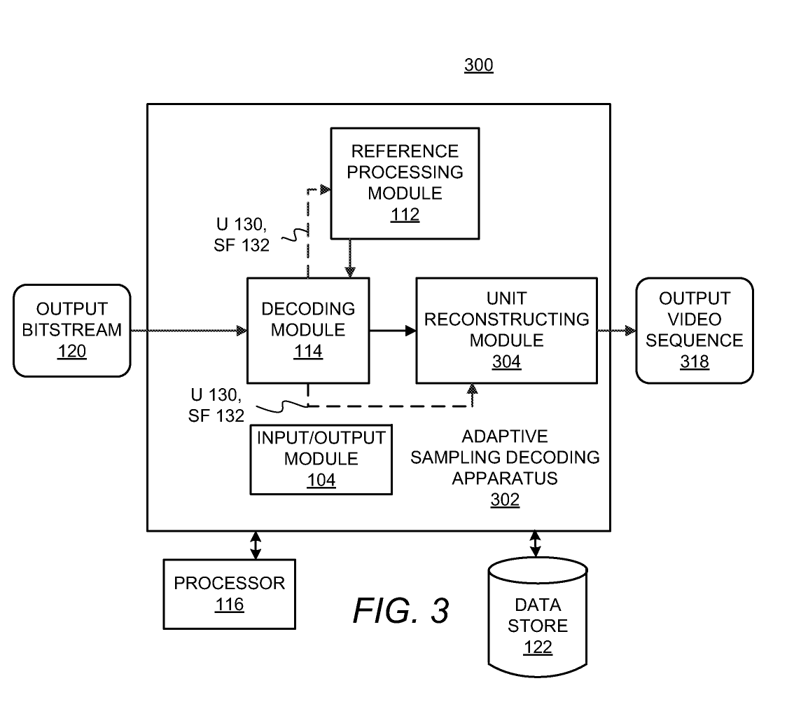

Turning now to FIG. 3, there is shown a simplified block diagram of an adaptive sampling decoding system 300, according to an example. It should be understood that the adaptive sampling decoding system 300 depicted in FIG. 3 may include additional components and that some of the components described herein may be removed and/or modified without departing from a scope of the adaptive sampling decoding system 300.

The adaptive sampling decoding system 300 includes an adaptive sampling decoding apparatus 302 to decode an adaptively sampled output bit stream 120. Examples of the adaptive sampling decoding apparatus 302 include, but are not limited to, the decoding module 114 described hereinabove with respect to FIG. 1. The adaptive sampling decoding system 300 decodes, and up-samples, based on the sampling formats used in the adaptive sampling encoding apparatus 102, the output bit stream 120 received by the adaptive sampling decoding apparatus 302. The adaptive sampling decoding system 300 also includes a processor 116 and a data store 122, similar to the adaptive sampling encoding system 100 described with respect to FIG. 1 hereinabove.

The adaptive sampling decoding apparatus 302 is depicted as including an input/output module 104, a reference processing module 112, a decoding module 114, and a unit reconstructing module 304. The unit reconstructing module 304 reconstructs the full resolution picture from the sampled picture. This can be performed by interpolation, for example, by upsampling and post-filtering. The filters using in the unit reconstructing module 304 can also be used in the reference processing module 112. The adaptive sampling decoding apparatus 302 may comprise, for instance, a decoder in a set top box or device that receives the output bit stream 120 from the adaptive sampling decoding apparatus 302 and processes the output bit stream 120 to be in a format for display on a television, computer monitor, personal digital assistant (PDA), cellular telephone, etc. According to an example, the adaptive sampling decoding apparatus 302 comprises a device and/or software integrated into one or more of televisions, computers, cellular telephones, PDAs, etc.

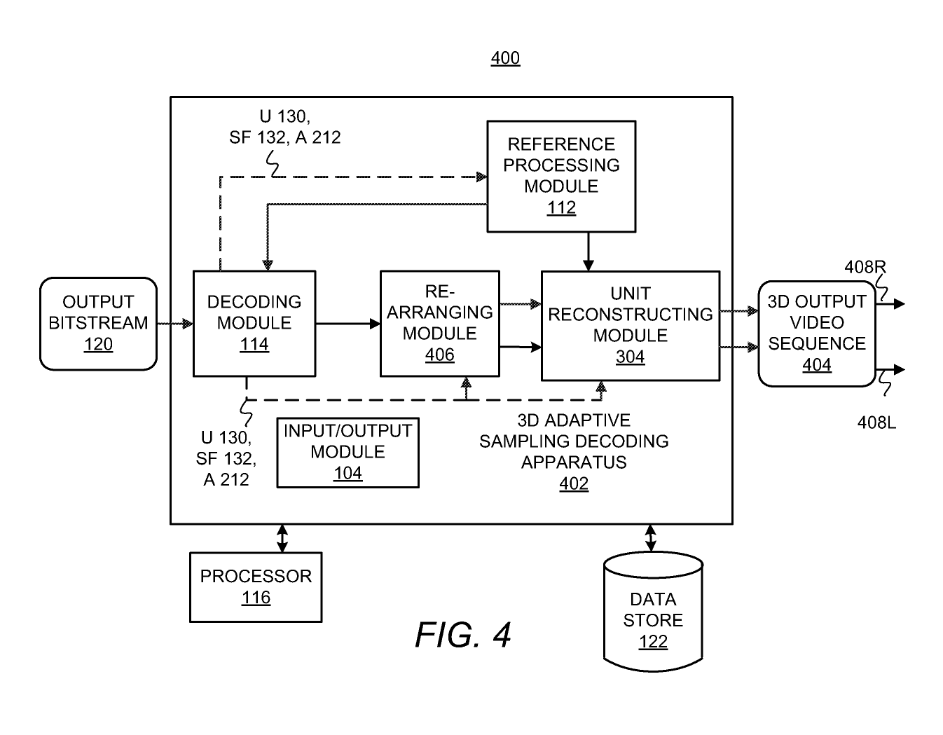

Turning now to FIG. 4, there is shown a simplified block diagram of a 3D adaptive sampling decoding system 400, according to an example. It should be understood that the 3D adaptive sampling decoding system 400 depicted in FIG. 4 may include additional components and that some of the components described herein may be removed and/or modified without departing from a scope of the 3D adaptive sampling decoding system 400. The 3D adaptive sampling decoding system 400 is a particular application of the adaptive sampling decoding system 300 disclosed with respect to FIG. 3 hereinabove. As such, the 3D adaptive sampling decoding system 400 includes many of the same elements as those depicted in the adaptive sampling decoding system 300 in FIG. 3.

The 3D adaptive sampling decoding system 400 includes a 3D adaptive sampling decoding apparatus 402 to decode an adaptively sampled 3D output bit stream 120. The adaptive sampling decoding system 400 also includes a processor 116 and a data store 122, similar to the adaptive sampling encoding system 100 described with respect to FIG. 1 hereinabove. In addition to the input/output module 104, the reference processing module 112, the decoding module 114 and the unit reconstructing module 304, described hereinabove with respect to the adaptive sampling decoding apparatus 302 and FIG. 3, the 3D adaptive sampling decoding apparatus 402 includes a re-arranging module 406.

The 3D adaptive sampling decoding system 400 receives the output bit stream 120 including the U 130, the SF 132, and the A 212 for each unit of the 3D input video 204. The re-arranging module 406 forms two decoded video portion corresponding to a left eye view and a right eye view using the decoded output from the decoding module 114. The unit reconstructing module 304 reconstructs the two full resolution views to form a full 3D output video 404. The full 3D output video 404 includes a reconstructed left eye view video 408L and a reconstructed right eye view video 408R.

Examples of methods in which the adaptive sampling encoding system 100, the 3D adaptive sampling encoding system 200, the 3D adaptive encoding system 250, the adaptive sampling decoding system 300 and the 3D adaptive sampling decoding system 400 may be employed for encoding and decoding an input video sequence are now described with respect to the following flow diagrams of the methods 500, 600, 650, 700 and 800 depicted in FIGS. 5, 6, 6B, 7 and 8. It should be apparent to those of ordinary skill in the art that the methods 500, 600, 700 and 800 represent generalized illustrations and that other processes may be added or existing processes may be removed, modified or rearranged without departing from the scopes of the methods 500, 600, 650, 700 and 800.

The descriptions of the methods 500, 600, 650, 700 and 800 are made with reference to the adaptive sampling encoding system 100, the 3D adaptive sampling encoding system 200, the 3D adaptive encoding system 250, the adaptive sampling decoding system 300, and the 3D adaptive sampling decoding system 400 depicted in FIGS. 1, 2A, 2B, 3 and 4 and thus makes particular reference to the elements contained in the adaptive sampling encoding system 100, the 3D adaptive sampling encoding system 200, the 3D adaptive encoding system 250, the adaptive sampling decoding system 300 and the 3D adaptive sampling decoding system 400. It should, however, be understood that the methods 500, 600, 650, 700 and 800 may be implemented in apparatuses that differs from the adaptive sampling encoding system 100, the 3D adaptive sampling encoding system 200, the 3D adaptive encoding system 250, the adaptive sampling decoding system 300, and the 3D adaptive sampling decoding system 400 without departing from the scopes of the methods 500, 600, 650, 700 and 800.

Some or all of the operations set forth in the methods 500, 600, 650, 700 and 800 may be contained as one or more computer programs stored in any desired computer readable medium and executed by a processor on a computer system. Exemplary computer readable media that may be used to store software operable to implement the invention include but are not limited to conventional computer system RAM, ROM, EPROM, EEPROM, hard disks, or other data storage devices.

With particular reference to FIG. 5, at block 502, an input video 118 is accessed, for instance by an input/output module 104 of the adaptive sampling encoding system 100 disclosed with respect to FIG. 1 hereinabove. For instance, the adaptive sampling encoding system 100 may access the input video 118 by receiving the input video 118 at the input/output module 104 from a content provider. Alternately, the adaptive sampling encoding system 100 may access the input video 118 by retrieving the input video 118 from a data store 122.

At block 504, U 130, a unit type, is determined for the input video 118, for instance by the unit analysis module 106 as described hereinabove with respect to FIG. 1. The U 130 may be selected from unit types such as but not limited to, group of pictures, picture, slice, group of blocks, macroblock and sub-macroblock.

At block 506, SF 132, a sampling format, is determined for the input video 118, for instance by the unit analysis module 106 as described hereinabove with respect to FIG. 1. The video may have a unit type, U 130, such as determined at block 504. For instance, the unit analysis module 106 analyzes the input video 118 to determine which sampling format preserves the most information. For instance, the input video 118 may be converted to the frequency domain in instances in which each sampling format has an associated frequency response. Different frequency responses of available sampling formats may be compared for the input video 118 and the sampling format preserving the most energy is chosen as SF 132. For example, a transform, such as but not limited to a 2-D block discrete cosine transform (DCT), 2-D Fourier transform, or Hadamard transform, may be applied to the unit and based on sub-band energy, the sampling format SF 132 may be determined.

According to an example, the SF 132 is determined from horizontal and vertical sampling directions used on the input video 118, for instance video X, in which the U 130 is an N×M block. 2D M×N block discrete cosine transform (DCT) is applied to the each M×N block of video X to generate corresponding M×N block frequency response, Y in frequency domain. From the energy characteristics of vertical sampling (upper (M/2)×N pixels) and horizontal sampling (left M×(N/2) pixels) in the frequency domain, the SF 132 preserving more energy is selected as the best sampling format. For example, in an instance in which the sum of the squared upper (M/2)×N pixels is greater than the sum of the squared left M×(N/2) pixels, vertical sampling is chosen.

At block 508, the input video 118 is sampled, for instance by the sampling module 108, using the sampling format determined at block 506. For example, the sampling module 108 may pre-filter and sample the input video 118 using the determined sampling format, SF 132, to form a horizontal or a vertical video portion.

At block 510, a sampling format of a reference video is determined, for instance by the reference processing module 112. The reference processing module 112 may determine the sampling format of the reference video by receiving the sampling format of the reference video from the decoding module 114.

At block 512, a determination whether the sampling format, SF 132, of the current video portion that is to be encoded matches the sampling format of the reference video is made, for instance by the reference processing module 112. For example, the reference processing module 112 may compare the sampling format of the reference video with the sampling format, SF 132, of the current video portion to be encoded.

At block 514, in instances in which the SF 132 of the current video portion to be encoded and the sampling format of the reference video are consistent, the reference video may be used directly, and is therefore output to the encoding module 110. The video portion is encoded to form an output bit stream 120, for instance by the encoding module 110. The encoding module 110 uses the reference video for predictive coding of the current video portion.

However, at block 516, in instances in which the SF 132 of the video portion to be currently encoded and the sampling format of the reference video are not consistent, the reference processing module 112 may encode the current video portion based on a selected reference processing mode. The reference processing mode may include reshaping the reference video to have a same sampling format of the current video portion and encoding the current video portion using the re-shaped reference video. The reference processing mode may also include removing the reference video inconsistent with the current video portion from a reference buffer and encoding the current video portion using modified reference buffer. The reference processing mode may include including the reference video in the reference buffer and encoding the current video portion using the reference video in the buffer as is without reshaping as exemplified in Table 3 for H.264/AVC.

In the instance in which the reference processing mode is reshaping the reference video, the reference processing module 112 may reshape the reference video so that the sampling format of the reshaped reference video is consistent with the SF 132 of the video portion to be currently encoded. More particularly, the reference processing module 112 may reconstruct the reference video to form a reconstructed reference video. The reconstructed reference video is sampled using the sampling format of the current video portion to form the re-shaped reference video.

Turning now to FIG. 6A, a method 600 is shown. The method 600 is an implementation of the method 500 for adaptive sampling in a 3D implementation. The method 600 may be implemented using prediction, transform, quantization and entropy coding by H.264/AVC. The method 600 is described with respect to FIG. 2A and the 3D adaptive sampling encoding system 200.

At block 602, 3D input video 204 is accessed, for instance by an input/output module 104 of the 3D adaptive sampling encoding system 200 disclosed with respect to FIG. 2A hereinabove. The 3D input video 204 includes a left eye view video 210L and a right eye view video 210R. For instance, the 3D adaptive sampling encoding system 200 may access the input video 118 by receiving the 3D input video 204 at the input/output module 104 from a content provider. Alternately, the 3D adaptive sampling encoding system 200 may access the 3D input video 204 by retrieving the 3D input video 204 from a data store 122.

At block 604, U 130, a unit type, is determined for the 3D input video 204, for instance by the unit analysis module 106 as described hereinabove with respect to FIG. 2A. The U 130 may be selected from unit types such as but not limited to, group of pictures, picture, slice, group of blocks, macroblock and sub-macroblock. The unit type, U 130, is determined for the left eye view video 210L and the right eye view video 210R of the 3D input video 204.

At block 606, the 3D input video 204 is analyzed, for instance by the unit analysis module 106 and a sampling format is determined. For instance, the 3D input video 204 may be analyzed to determine which sampling format preserves the most information, similarly as described at block 506 of the method 500 hereinabove, for the left eye view video 210L and the right eye view video 210R of the 3D input video 204.

At block 608, the 3D input video 204 is sampled, for instance by the sampling module 108, using the sampling format determined at block 606. For example, the sampling module 108 may sample the 3D input video 204 using the determined sampling format, SF 132, to form a horizontal or a vertical video portion for each of the left eye view video 210L and the right eye view video 210R to form a left eye view video portion and a right eye view video portion.

At block 610, the left eye view video portion and the right eye view video portion are arranged in a single video portion, for instance by the arranging module 206, using an arrangement type. For example, the arranging module 206 may arrange the left eye view video portion and the right eye view video portion using the arrangement type, A 212, to form a single video portion.

At block 612, a reference video is determined based on the sampling format, SF 132, of the left eye view video portion and the right eye view video portion that are currently to be encoded, for instance by the reference processing module 112. Similarly as described hereinabove at blocks 510, 512, 514 and 516 of the method 500, the reference processing module 112 may compare the sampling format of the reference video with the sampling format, SF 132, of the current video portions to be encoded, in this instance for the left eye view video portion and the right eye view video portion, to determine reference video for the left eye view video portion and the right eye view video portion that are currently to be encoded. The video portions are encoded to form an output bit stream 120, for instance by the encoding module 110. The encoding module 110 uses the reference video for predictive coding of the video portion that it is currently encoding.

Turning now to FIG. 6B, a method 650 is shown. The method 650 is an implementation of the method 600 for adaptive sampling in a 3D implementation using FP SEI 254. The method 650 may be implemented using prediction, transform, quantization and entropy coding by H.264/AVC. The method 650 is described with respect to FIG. 2B and the 3D adaptive sampling encoding system 250.

Similar to the method 600, described at blocks 602, 606, 608 and 610, at blocks 652, 656, 660 and 662 of the method 650, the 3D input video 204 is accessed, analyzed and sampling formats may be determined for the 3D input video 204. The 3D video input is also sampled and arranged as described hereinabove with respect to FIG. 6A. In instances in which FP SEI 254 is used to sample 3D input video, unit type may be fixed as a picture, therefore block 604 in the method 600 is not required.

Additionally at block 658, however, as described with respect to FIG. 2B hereinabove, an FP SEI 254 may be output from the unit analysis module 106 to the encoding module 110. At block 664 the arranged video portion may be encoded along with the FP SEI 254.

According to an example, the encoding module 110 may add to, for instance of H.264/AVC, a sequence parameter set RBSP syntax in the output bit stream 120 to signal a decoder that receives the output bit stream 120. For instance as shown in Table 1, new syntax video mode may indicate the bitstream contains 2D video or 3D video data.

TABLE 1
Definition of video mode in adaptive sampling

| video mode | Definition |
|---|---|
| 0 | 2D video |
| 1 | 3D video |

Further, the encoding module 110 may add to, for instance of H.264/AVC, a picture parameter set RBSP syntax in the output bit stream 120 to signal a decoder that receives the output bit stream 120. For instance, the encoding module 110 may add a picture sampling mode (hereinafter pic sampling mode) parameter such as in Table 2 to signal the SF 132 of each unit determined hereinabove at block 506. In instances in which pic sampling mode is equal to 0, there is no sampling operation involved. Otherwise, an input unit is a sampled unit in side-by-side, top-bottom or checkerboard-SS format. The checkerboard format is defined as ‘quincunx sampling and pixels rearranged to have side-by-side’.

TABLE 2
Definition of pic sampling mode

| pic sampling | |
|---|---|
| mode | Definition |
| 0 | No sub-sampling |
| 1 | Vertically shaped block by horizontal sub- |
| | sampling |
| 2 | Horizontally shaped block by vertical sub- |
| | sampling |
| 3 | Horizontally shaped block by checkerboard sub- |
| | sampling and pixel arrangement |

Additionally, the pic sampling mode may include information regarding an original width (w) and height (h) of the unit of the current picture. For instance, associated meanings for different values may be assigned as in Table 3.

TABLE 3
Definition of sub-sampled picture size

| pic | | Sub- | Sub- |
|---|---|---|---|
| sampling | | sampled | sampled |
| mode | Definition | width | height |
| 0 | No sub-sampling | w | h |
| 1 | Horizontal sub-sampling | w/2 | h |
| 2 | Vertical sub sampling | w | h/2 |
| 3 | Checkerboard sub sampling | w/2 | h |
| | and pixel arrangement | | |

Further, in instances in which the pic sampling mode indicates the current picture is sub-sampled either horizontally or vertically, an additional syntax, hereinafter referred to as reference processing mode, may be included in the picture parameter set of a raw byte sequence payload (RBSP) as illustrated in Table 4. The reference processing mode comprises a flag that enables/disenables a flexible temporal reference handling option.

TABLE 4
Definition of reference processing mode in picture parameter set

| reference | |
|---|---|
| processing mode | Definition |
| 0 | Adaptive reference processing |
| 1 | Use only the same sampling mode |
| 2 | Use as is |

According to the example described with respect to Table 4, in instances in which reference processing mode is equal to 0, the current unit to be encoded may use any marked unit in the reference buffer as reference unit, irrespective of the SF 132 of the marked unit after adaptive reference processing. In instances in which the reference unit has a different SF 132, the reference unit is first up-sampled to full resolution and then down-sampled in the same way as the unit to be currently encoded. Alternatively, the reference unit may be reshaped in a single step. In instances in which the reference processing mode is equal to 1, the unit to be currently encoded may only use the reference units with the same sub-sampling format, i.e. SF 132. Note that in this instance, a reference index is to be re-assigned with indexes with different sampling formats skipped. In an instance in which the reference processing mode is equal to 2, adaptive reference processing may be disabled and the original references in reference picture buffer used to encode the unit as is.

Table 5 exemplifies new syntax, the arrangement type, to signal A212 in FIG. 2A.

TABLE 5
Definition of arrangement type in adaptive sampling

| arrangement type | Definition |
|---|---|
| 0 | Horizontal cascading |
| 1 | Vertical cascading |

Table 6 shows how U130, SF132 and A212 can be defined according to frame packing arrangement type (defined in FP SEI 254) when FP SEI 254 is used.

TABLE 6
Mapping of U130, SF132 and A212 for FP SEI 254

| Frame packing | | | |
|---|---|---|---|
| arrangement type | U130 | SF132 | A212 |
| 3 | Picture | Pic sampling | Arrangement |
| | | mode = 1 | type = 0 |
| 4 | picture | Pic sampling | Arrangement |
| | | mode = 2 | type = 1 |

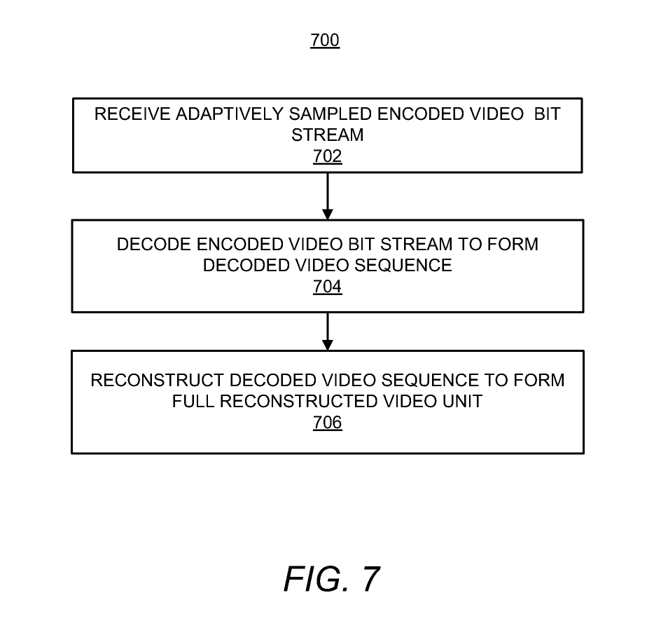

Turning now to FIG. 7, a method 700 is shown. The method 700 is described with respect to the adaptive sampling decoding system 300 described with respect to FIG. 3 hereinabove and thus makes particular reference to the elements contained in the adaptive sampling decoding system 300. More particularly, the method 700 describes the decoding of an adaptively sampled output bit stream 120 using additional information at the adaptive sampling decoding apparatus 302.

At block 702, an adaptively sampled encoded video portion, for instance the output bit stream 120, is received, for instance by the input/output module 104 of the adaptive sampling decoding system 300. The output bit stream 120 may be received from an adaptive sampling encoding system 100. The output bit stream 120 may include information that indicates the U 130, and the SF 132 of the adaptively sampled video content.

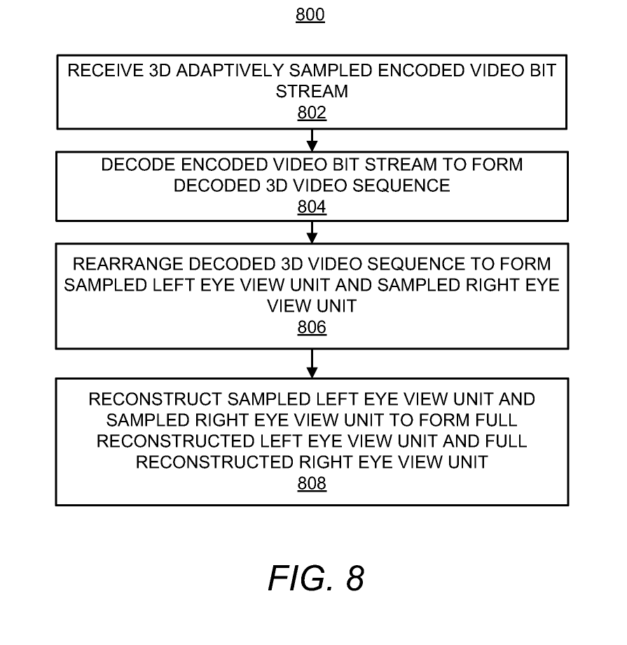

At block 704, the output bit stream 120 is decoded, for instance by the decoding module 114, to form a decoded bit stream. The decoded bit stream is a sequence having adaptively sampled content. The decode bit stream may comprise 2D video content, or, as described with respect to FIG. 8 and the method 800, 3D video content. The output bit stream 120 may be decoded using the reference processing module 112 and the reference video may be stored in a reference buffer.

At block 706, the decoded bit stream is reconstructed, for instance by the unit reconstructing module 304 to form full reconstructed video. The unit reconstructing module 304 may perform this reconstruction by upsampling the decoded video using the SF 132 received with the adaptively sampled encoded video sequence.

Turning now to FIG. 8, a method 800 is shown. The method 800 is described with respect to the 3D adaptive sampling decoding system 400 described with respect to FIG. 4 hereinabove and thus makes particular reference to the elements contained in the 3D adaptive sampling decoding system 400. More particularly, the method 800 describes the decoding of an adaptively sampled output bit stream 120 using additional information at the 3D adaptive sampling decoding apparatus 402.

At block 802, an adaptively sampled encoded video sequence, for instance the output bit stream 120, is received, for instance by the input/output module 104 of the 3D adaptive sampling decoding system 400. The output bit stream 120 may be received from a 3D adaptive sampling encoding system 200. The output bit stream 120 may include information that indicates the U 130, the SF 132 and the A 212 of the adaptively sampled 3D video content. An example of such information for backward-compatibility includes the specific case of SEI messages, FP SEI 254.

At block 804, the output bit stream 120 is decoded, for instance by the decoding module 114, to form a decoded video portion. The decoded video portion is a video portion having adaptively sampled 3D content, including a left eye view video portion and a right eye view video portion. The output bit stream 120 is decoded using the reference processing module 112.

At block 806, the decoded video portion is rearranged to form two separate video portions, for instance by the rearranging module 406. For example, in an instance in which the output video portion was previously arranged according to an arrangement type A 212, such as but not limited to side-by-side or top-bottom, the rearranging module 406 separates the output sequence into two video portions. In order to rearrange the decoded video portion, the rearranging module 406 accesses additional information received in the output bit stream 120 to determine the A 212.

At block 808, the two separate video portions are reconstructed, for instance by the unit reconstructing module 304 to form a reconstructed left eye view video portion 408L and a reconstructed right eye view video portion 408R. The unit reconstructing module 304 performs this reconstruction for the separate left eye view and right eye view video portions by, for instance, upsampling each of the video portions. The full 3D output video that includes the reconstructed left eye view video and the reconstructed right eye view video may then be output for presentation at a connected display.

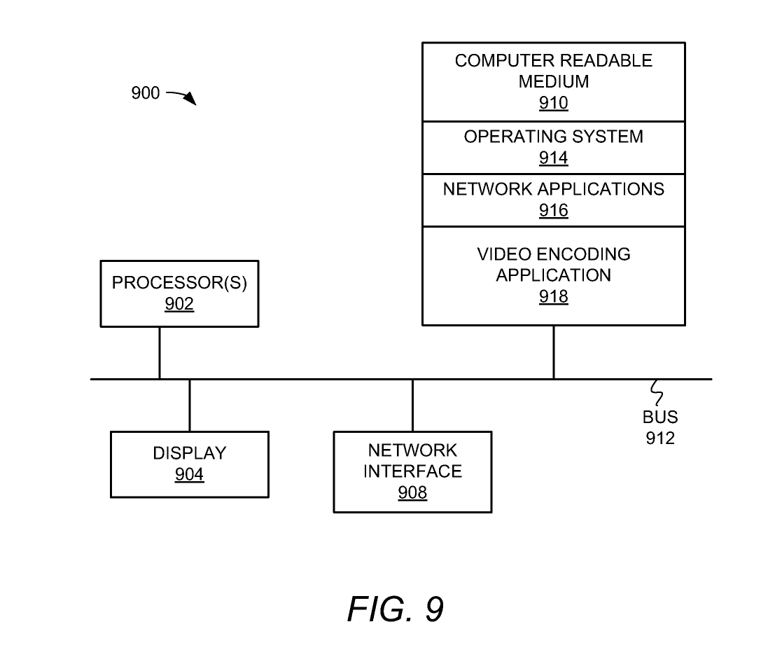

Turning now to FIG. 9, there is shown a schematic representation of a computing device 900 configured in accordance with embodiments of the invention. The computing device 900 includes one or more processors 902, such as a central processing unit; one or more display devices 904, such as a monitor; one or more network interfaces 908, such as a Local Area Network LAN, a wireless 802.11x LAN, a 3G mobile WAN or a WiMax WAN; and one or more computer-readable mediums 910. Each of these components is operatively coupled to one or more buses 912. For example, the bus 912 may be an EISA, a PCI, a USB, a FireWire, a NuBus, or a PDS.

The computer readable medium 910 may be any suitable medium that participates in providing instructions to the processor 902 for execution. For example, the computer readable medium 910 may be non-volatile media, such as an optical or a magnetic disk; volatile media, such as memory; and transmission media, such as coaxial cables, copper wire, and fiber optics. Transmission media can also take the form of acoustic, light, or radio frequency waves. The computer readable medium 910 may also store other software applications, including word processors, browsers, email, Instant Messaging, media players, and telephony software.

The computer-readable medium 910 may also store an operating system 914, such as Mac OS, MS Windows, Unix, or Linux; network applications 916; and a video encoding/decoding application 918. The operating system 914 may be multi-user, multiprocessing, multitasking, multithreading, real-time and the like. The operating system 914 may also perform basic tasks such as recognizing input from input devices, such as a keyboard or a keypad; sending output to the display 904; keeping track of files and directories on medium 910; controlling peripheral devices, such as disk drives, printers, image capture device; and managing traffic on the one or more buses 912. The network applications 916 include various components for establishing and maintaining network connections, such as software for implementing communication protocols including TCP/IP, HTTP, Ethernet, USB, and FireWire.

The video encoding application 918 provides various software components for encoding video content, as discussed above. In certain embodiments, some or all of the processes performed by the application 918 may be integrated into the operating system 914. In certain embodiments, the processes can be at least partially implemented in digital electronic circuitry, or in computer hardware, firmware, software, or in any combination thereof, as also discussed above.

Embodiments of the invention provide a method and apparatus for encoding and decoding video content. The method and apparatus may be used to analyze and decide a sampling or sub-sampling direction, when video content is encoded, that reduces bits used to encode the video content and/or preserves information in the encoded video content.

What has been described and illustrated herein are embodiments of the invention along with some of their variations. The terms, descriptions and figures used herein are set forth by way of illustration only and are not meant as limitations. Those skilled in the art will recognize that many variations are possible within the spirit and scope of the invention, wherein the invention is intended to be defined by the following claims—and their equivalents—in which all terms are meant in their broadest reasonable sense unless otherwise indicated.

What is claimed is:

1. A method of encoding video, the method comprising:
analyzing, by a processor, the video to determine a sampling format for the video from a plurality of sampling formats;
sampling the video using the determined sampling format to produce a video portion having a subset of information of the video; and
encoding the video portion to form an output bit stream.

2. The method of claim 1, further comprising:
analyzing the video to determine a unit type for the video from a plurality of unit types, wherein the unit type comprises one of a group of pictures, a picture, a slice, a group of blocks, macroblocks and sub-macroblocks, and the unit type substantially maximizes coding efficiency.

3. The method of claim 1, wherein analyzing the video to determine the sampling format for the video from the plurality of sampling formats comprises:
converting the video to a frequency domain; and
performing an energy comparison in the frequency domain to determine the sampling format that that substantially maximizes coding efficiency.

4. The method of claim 1, wherein encoding the video portion comprises:
determining reference video corresponding to current video portion to be encoded;
determining a sampling format of the reference video;
determining whether the sampling format of the reference video matches the sampling format of the current video portion;
if the sampling formats match, using the reference video to encode the current video portion; and
if the sampling formats do not match, encoding the current video portion based on a reference processing mode.

5. The method of claim 4, wherein encoding the current video portion based on the reference processing mode comprises one of:
reshaping the reference video to have a same sampling format of the current video portion and encoding the current video portion using the re-shaped reference video;
removing the reference video from a reference buffer and encoding the current video portion using modified reference buffer; and
including the reference video in the reference buffer and encoding the current video portion using the reference buffer as is.

6. The method of claim 5, wherein reshaping the reference video comprises:
reconstructing the reference video to form a reconstructed reference video;
sampling the reconstructed reference video using the sampling format of the current video portion to form the re-shaped reference video.

7. The method of claim 1, wherein the video comprises a 3D video including a left eye view video and a right eye view video, the method comprising:
sampling the left eye view video and the right eye view video using the determined sampling format to generate a left eye view video portion and a right eye view video portion.
selecting an arrangement type for the left eye view video portion and the right eye view video portion;
arranging the left eye view video portion and the right eye view video portion using the selected arrangement type to form a single video portion; and
wherein the encoding comprises encoding the single video portion.

8. The method of claim 1, further comprising
determining a frame packing supplemental enhancement information (SEI) indicator, wherein the frame packing SEI is operable to indicate to the decoder an arrangement type, a unit type and a sampling format for each unit in the output bit stream;
determining the arrangement type, the unit type, and the sampling format adaptively to maximize coding efficiency; and
wherein encoding the video portion to form an output bit stream includes encoding the frame packing SEI.

9. A method of decoding a bit stream, the method comprising:
receiving the bit stream having an encoded video portion, and a sampling format previously used to sample the video portion prior to encoding;
decoding, by a processor, the encoded video portion to form a decoded video portion; and
upsampling the decoded video portion based on the sampling format to generate a full video.

10. The method of claim 9, further comprising:
receiving video having a unit type, wherein the unit type is previously determined from a plurality of unit types, comprises one of a group of pictures, a picture, a slice, a group of blocks, and macroblocks, and substantially maximizes coding efficiency.

11. The method of claim 9, wherein the decoding comprises:
determining reference video corresponding to current video portion to be decoded;
determining a sampling format of the reference video;
determining whether the sampling format of the reference video matches the sampling format of the current video portion;
if the sampling formats match, using the reference video to decode the current video portion; and
if the sampling formats do not match, decoding the current video portion based on a reference processing mode.

12. The method of claim 11, wherein decoding the current video portion based on the reference processing mode comprises one of:
reshaping the reference video to have a same sampling format of the current video portion and decoding the current video portion using the re-shaped reference video;
removing the reference video from a reference buffer and decoding the current video portion using modified reference buffer; and
including the reference video in the reference buffer and decoding the current video portion using the reference video.

13. The method of claim 12, wherein reshaping the reference video comprises:
reconstructing the reference video to form a reconstructed reference video; and
sampling the reconstructed reference video using the sampling format of the current video portion to form the re-shaped reference video.

14. The method of claim 9, comprising:
receiving an arrangement type for the decoded video portion, wherein the decoded video portion comprises a single video portion; and
rearranging the decoded single video portion based on the arrangement type to form a left eye view video portion and a right eye view video portion.

15. The method of claim 14, further comprising upsampling the left eye view video portion and the right eye view video portion based on the received sampling format to generate a full 3D video.

16. An encoder comprising:
a module to analyze video to determine a sampling format for the video from a plurality of sampling formats, sample the video using the determined sampling format to produce a video portion having a subset of information of the video, and encode the video portion to form an output bit stream; and
a processor configured to implement the module.

17. The encoder of claim 16, wherein the module is further to analyze the video to determine a unit type for the video from a plurality of unit types, wherein the unit type comprises one of a group of pictures, a picture, a slice, a group of blocks, and macroblocks and the unit type substantially maximizes coding efficiency.

18. The encoder of claim 16, wherein to analyze the video to determine the sampling format for the video from the plurality of sampling formats, the module is to convert the video to a frequency domain, and perform an energy comparison in the frequency domain to determine the sampling format that that substantially maximizes coding efficiency.

19. The encoder of claim 16, wherein to encode the video portion to form the output bit stream, the module is to determine reference video corresponding to current video portion to be encoded, determine a sampling format of the reference video, determine whether the sampling format of the reference video matches the sampling format of the current video portion, if the sampling formats match, use the reference video to encode the current video portion, and if the sampling formats do not match, encode the current video portion based on a reference processing mode.

20. The encoder of claim 19, wherein to encode the current video portion based on the reference processing mode, the module is to perform one of:
reshape the reference video to have a same sampling format of the current video portion and encode the current video portion using the re-shaped reference video,
remove the reference video from a reference buffer and encode the current video portion using modified reference buffer; and
include the reference video in the reference buffer and encode the current video portion using the reference video.

21. The encoder of claim 20, wherein to reshape the reference video the module is to reconstruct the reference video to form a reconstructed video, and sample the reconstructed reference video using the sampling format of the current video portion to form the re-shaped reference video.

22. The encoder of claim 16, wherein the video comprises a 3D video including a left eye view video and a right eye view video, and wherein the module is to sample the left eye view video and the right eye view video using the determined sampling format to generate a left eye view video portion and a right eye view video portion, and wherein the module is to select an arrangement type for the left eye view video portion and the right eye view video portion, arrange the left eye view video portion and the right eye view video portion using the selected arrangement type to form a single video portion, and encode the single video portion.

23. The encoder of claim 16, wherein the module is to determine a frame packing supplemental enhancement information (SEI) indicator, wherein the frame packing SEI is operable to indicate to the decoder an arrangement type, a unit type and a sampling format for each unit in the output bit stream;
wherein the module is to determine the arrangement type, the unit type, and the sampling format adaptively to maximize coding efficiency; and
wherein to encode the video portion to form the output bit stream the module includes the frame packing SEI.

24. A decoder comprising:
a module to receive a bit stream having an encoded video portion, and a sampling format previously used to sample the video portion prior to encoding, decode the encoded video portion to form a decoded video portion, and upsample the decoded video portion based on the sampling format to generate a full video; and
a processor configured to implement the module.

25. The decoder of claim 24, wherein the module is further to receive a unit type of the encoded video portion, wherein the unit type is previously determined from a plurality of unit types, comprises one of a group of pictures, a picture, a slice, a group of blocks, and macroblocks, and substantially maximizes coding efficiency.

26. The decoder of claim 24, wherein the module is to determine reference video corresponding to current video portion to be decoded, determine a sampling format of the reference video, determine whether the sampling format of the reference video matches the sampling format of the current video portion, if the sampling formats match, use the reference video to decode the current video portion, and if the sampling formats do not match, decode the current video portion based on a reference processing mode.

27. The decoder of claim 26, wherein the module is to decode the current video portion based on the reference processing mode, the module is to perform one of:
reshape the reference video to have a same sampling format of the current video portion and encode the current video portion using the re-shaped reference video,
remove the reference video from a reference buffer and encode the current video portion using modified reference buffer; and
include the reference video in the reference buffer and encode the current video portion using the reference video.

28. The method of claim 27, wherein to reshape the reference video the module is to reconstruct the reference video to form a reconstructed video, and sample the reconstructed reference video using the sampling format of the current video portion to form the re-shaped reference video.

29. The method of claim 24, wherein the module is to receive an arrangement type for the decoded video portion, wherein the decoded video portion comprises a single video portion, and rearrange the decoded single video portion based on the arrangement type to form a left eye view video portion and a right eye view video portion.

30. The method of claim 29, wherein the module is to upsample the left eye view video portion and the right eye view video portion based on the received sampling format to generate a full 3D video.
